(19) United States
(12) Patent Application Publication
(10) Pub. No.: US 2008/0078364 A1
(43) Pub. Date: Apr. 3, 2008

(54) Method and apparatus for increasing power of a diesel engine by continuously heating the fuel

(76) Inventors: Sergey Antonov, Toronto (CA); Alexei I. Antonov, Toronto (CA)

Correspondence Address: SERGEY ANTONOV, 11 Michael Power Place, PH 15, TORONTO, ON, M9A 5G3, US

(21) Appl. No.: 11/536,649

(22) Filed: Sep. 29, 2006

(51) Int. Cl. F02G 5/00; F02M 69/04

(52) U.S. Cl. 123/558; 123/445

(57) ABSTRACT

The invented method and apparatus increase power of a diesel engine by heating of the fuel inside a fuel path of the diesel engine before its injection into a combustion chamber. Lighter hydrocarbons, produced during continuously heating the fuel to a high temperature and under a high pressure, help boiling of the fuel injected into the combustion chamber. High fuel temperatures and its fast boiling speed up the combustion.

This invention increases power, torque and efficiency of a diesel engine. Also, it allows using gasoline as diesel fuel.

It is well known that a diesel engine has some advantages over a gasoline one, such as very good fuel efficiency and higher torque characteristics. Moreover, diesel fuel is noticeably cheaper to produce than gasoline. Diesel engines could totally replace gasoline ones, but there are few factors limiting use of diesel engines. They can not produce as much power as gasoline engines and they are in some ways less environmentally friendly. These drawbacks are related to the nature of the used fuel and to the engines' design. In our invention we have made an attempt to improve the characteristics of diesel engines.

Diesel engines are known to start with difficulty during winter low temperatures. In order to improve cold start characteristics of diesel engines various fuel preheating systems are used. They warm up the fuel letting it come easily through the fuel path and be injected into the combustion chamber. That helps significantly decrease the amount of unburned fuel and reduce pollution impact on the environment. However, after the engine reaches its normal working temperature these systems are disabled. These preheating systems usually use electrical power.

This invention goes further with fuel heating to improve characteristics of diesel engines at their working temperature. To eliminate or at least reduce the difference in power characteristics between diesel and gasoline engines we need to make diesel fuel burn faster. So the way of increasing power of diesel engines can be using of diesel fuel at least partially in a gas state and injecting the fuel heated to a very high temperature, so that the fuel boils when it is injected into the combustion chamber. This can significantly speed up burning due to better dispersing of the fuel drops.

Heating can achieve cracking of diesel fuel under high pressure. We already have high pressure in diesel fuel injection system. To start a cracking process of diesel fuel, we just need to heat it above 400 degrees Centigrade. As a result of this reaction we should get lighter hydrocarbons. This better fuel injected into the combustion chamber, shall burn faster and more completely, increasing the engine's power and reducing pollution of environment. The maximum engine rotation frequency will rise as well.

Therefore, our idea is to create a cracking process of diesel fuel inside the fuel path of the diesel engine before its injection. To achieve that, we need to heat the fuel path to the fuel cracking temperature. For this purpose a few methods can be used.

An electrical heater can be installed on the fuel line. The existing fuel heating system for cold start can be used for that. The negative side of such system is high energy consumption reducing the power output of the engine and its fuel efficiency.

Existing furnace systems can be used for continuously heating the fuel as well. This type of the system takes a portion of fuel for the furnace.

The best method, from our point of view, is to use high temperature of the exhaust system to heat the fuel. The simplest way is to have the fuel path coiled around the exhaust outlet and covered by heat isolation. Usually the exhaust outlet temperatures are higher than the fuel cracking temperature and the fuel in the system will be sufficiently heated. That should improve the engine performance. This implementation of our invention is the most effective one, because it doesn't take any portion of the engine power for a continuous fuel heating. The down side of this variant is that it can not improve the characteristics of cold engines. Nevertheless, for a cold start any of other existing systems may be used.

Typical diesel engine operates by air compression following by fuel injection. Air is heated by air compression and therefore causes the ignition of said injected fuel. The air is compressed in a combustion chamber where the fuel is injected and where internal combustion is happening.

Fuel injection into combustion chamber of the diesel engine is done by a fuel pump able to compress the fuel to at least 100 times atmospheric pressure and often above 1000 times atmospheric pressure. Injection into said combustion chamber is typically controlled by injecting valve by opening the valve at exact determined moment for exact determined time. Both are changed according to operation conditions for best engine performance. Typically injection valve is electronically controlled by a computerized engine control system. Mechanically controlled injection valve geared to crank shaft revolutions is also known.

High pressure metal hoses are used to connect the fuel pump to the injecting valve. The heating of the fuel is known in prior art and relatively common for variety of reasons, primarily to facilitate cold start of diesel engine. Other important reason for preheating the fuel is commonly known in prior art to facilitate engine operation on not-standard fuels: not-refined oil, cooking oil. All above mentioned preheating cases operate at comparatively low temperatures below 300 degrees Centigrade. Regular diesel fuel boils at about 300 degrees Centigrade at atmospheric pressure. In oil refining industry the process which produces light hydrocarbons from heavier ones is long known. Thermal cracking is performed by applying temperatures between 400 and 800 degrees Centigrade under pressure between 10 and 70 times atmospheric pressure. Thermal cracking produces a variety of light hydrocarbons like ethene and propene (−103.7 and −47.6 degrees Centigrade boiling temperature at atmospheric pressure), and decreases ignition temperature of the fuel.

The boiling temperature of gasoline at normal pressure is about 100 degrees Centigrade.

In a combustion chamber of the diesel engine at the moment of the fuel injection pressure is about 70 times atmospheric. That would require boiling temperatures above 300 degrees centigrade even for relatively light components such as propene. An important property of diesel fuel is its ability to ignite at relatively low temperatures produced by air compression cycle of the engine. In order to use gasoline or kerosene as a diesel fuel; conditions to be brought in to facilitate the ignition. Having fuel preheated to temperature above ignition point prior to injection into the combustion chamber allows to use light hydrocarbons fuels for diesel engine.

Temperature of the fuel is typically measured by electric circuit having a temperature sensitive resistive component often comprised of two different metals connected together. Such thermo-sensor is brought into contact with the fuel or fuel pathway, so electric properties of the sensor are monitored and temperature derived from said monitored electric properties.

Injection valve may be cooled conventionally by engine cooling system such as by liquid circulating through the valve or by air flow in case of air cooled engine.

As it is known in the art, thermo-isolation of components at high temperatures, such as those above 300 degrees Centigrade, is made by mineral isolating materials like asbestos and equivalents.

The preheating of the fuel is supposingly most efficient when the heat exchanger with an exhaust is used. This way no additional energy is required and only normally wasted heat of exhaust gases is utilized. External combustion heater has high efficiency often as good as 80-90 percent. Combustion heater will consume an additional fuel and part of that additional energy will be lost. The least efficient way to preheat the fuel is to use an electric heater. Electric heater derives its energy from additional fuel burned by the engine which is burden by inefficiencies of the engine and further burdened by the inefficiency of electric current generator.

The increased power of the engine is expected to come primarily from reduced cycle time and increased number of revolutions per minute. This is because preheated fuel will burn faster, due to vigorous boiling of the fuel, or some of its components, or due to the use of fast burning fuels like gasoline. Secondary cause of power increase is due to increase of working temperature in the combustion chamber. As fuel is preheated, the total heat of the components brought into the combustion chamber rises; consequently the products of the combustion will have a higher energy and therefore the pressure in the combustion chamber will increase accordingly. Higher working pressure increases torque, power and efficiency.

### PREFERRED EMBODIMENT

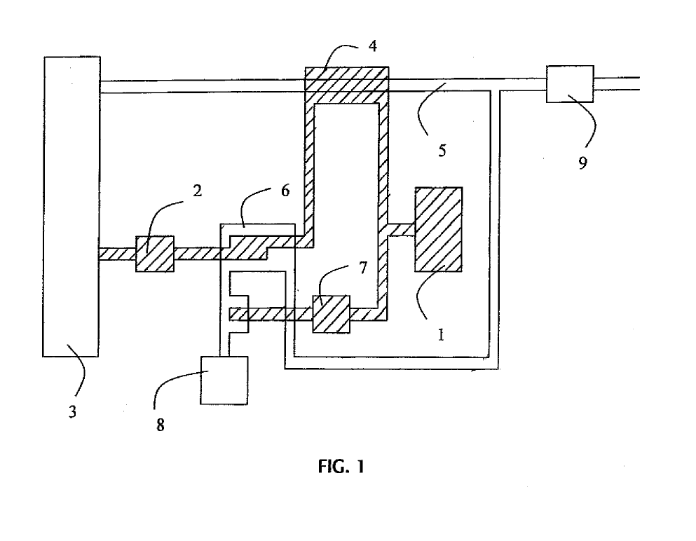

Preferred embodiment is shown below as a sample application of this invention. This sample application is suited for a car powered by a direct injection diesel engine. We strive to provide the most complete and full-featured embodiment shown in FIG. 1.

High pressure fuel pump 1. Injection control fuel valve 2. Direct injection diesel engine 3.

Heat exchanger 4 to heat compressed fuel by exhaust gases:

fuel pathway made of copper tube wrapped around exhaust path way 5;
or fuel pathway enters exhaust path way coiled inside and exits the exhaust pathway upstream;
or thermo-conductive body having independent, counterflow pathways for fuel and exhaust gases.

Heat exchangers of this kind are common to boilers and chemical reactors.

Heater 6 to heat compressed fuel by combustion heat produced specifically for this fuel heating by burning some of the fuel.

Heater control fuel valve 7 to regulate amount of fuel burned by the heater.

Air pump 8 to feed the heater 6 with air. This could be an electric fan.

Ignition means (not shown) to start combustion of fuel injected via valve 7 into airflow created by pump 8. This could be a spark-plug or a glow plug.

Temperature sensor (not shown) to measure fuel temperature at or before the valve 2. The sensor could be a thermo-couple.

Electronic circuit and/or computer means (not shown) to provide negative feedback control for the valve 7 based upon the temperature of the fuel. This will increase fuel injection into the heater 6 if the temperature is less than desired one and decrease fuel injection if the temperature is above desired value. This type of temperature control is common to boilers and chemical reactors.

Specifics are arising from relatively high fuel temperatures we recommend (300 to 900+degrees Centigrade). The exchanger, the heater and the injection valve are to be designed accordingly. Plastics or aluminum parts will not keep their strengths. Conventional solder contacts in electric circuits will melt; magnetic parts will loose their useful properties and so on.

High temperatures may cause high energy loss. Thermo-isolation is a must. Flammable materials coming in contact may ignite oil and plastic-isolated electrical wiring. Thermo-isolation shall prevent that.

Injection valve may need to be redesigned to avoid use of magnetic materials and other temperature sensitive parts. Alternatively, cooling of the valve's parts may be considered.

### Operation of this Preferred Embodiment:

First step activates battery powered the fuel pump 1 and the air pump 8. This compresses fuel and prepares for the heater's start.

Second step comes a while after, triggered by a timer or by a fuel pressure sensor. Second step activates the valve 7 and ignites fuel in the heater 6. This warms fuel and catalytic converter 9 preparing for the engine's start.

Third step comes a while after, triggered by a timer or by a fuel temperature sensor. Third step starts the engine.

Following is normal operation of the engine after warm-up. As engine warms, exhaust becomes hot, the exchanger heats fuel as well as heater does further increasing the fuel's temperature. At that point fuel temperature is regulated by the negative feedback control loop using the temperature sensor and the heater control valve 7.

What is claimed is:

1. A method for increasing power of an air-compression fuel-injection internal-combustion engine by continuously heating fuel, comprising the steps of:
compressing the fuel to a pressure higher than the pressure in a combustion chamber of the engine at the moment of fuel injection;
heating the fuel to at least 300 degrees Centigrade;
injecting the fuel into a combustion chamber of the engine.

2. The method, as claimed in claim 1, wherein the fuel is heated to at least its cracking temperature, so that lighter hydrocarbons are produced.

3. The method, as claimed in claim 1, wherein the fuel is heated to at least its boiling temperature, so that it boils when injected into a combustion chamber of the engine.

4. The method, as claimed in claim 1, wherein the fuel is heated to at least its ignition temperature, so that it ignites when injected into a combustion chamber of the engine.

5. The method, as claimed in claim 4, wherein the fuel is gasoline.

6. The method, as claimed in claim 4, wherein the fuel is kerosene.

7. A fuel injection system for an air-compression internal-combustion engine, comprising:
a fuel pump;
a fuel heater;
an injecting valve;
means connecting the pump to the heater and the heater to the valve, so that fuel is pumped, heated and injected into a combustion chamber of the engine.

8. The fuel injection system, as claimed in claim 7, having a heat exchanger, so that exhaust gases of the engine heat the fuel.

9. The fuel injection system, as claimed in claim 7, having means to measure temperature of the fuel.

10. The fuel injection system, as claimed in claim 9, having means to control an amount of heat produced by the heater in response to the measured temperature, so that the temperature of the fuel can be kept at a desired value.

11. The fuel injection system, as claimed in claim 8, wherein the heat exchanger comprises a fuel pathway wrapped around an exhaust pathway.

12. The fuel injection system, as claimed in claim 7, having means to cool the valve.

13. A fuel injection system for an air-compression internal-combustion engine, comprising:
a fuel pump;
a heat exchanger, so that exhaust gases of the engine heat the fuel;
an injecting valve;
means connecting the pump to the exchanger and the exchanger to the valve, so that fuel is pumped, heated and injected into a combustion chamber of the engine.

14. The fuel injection system, as claimed in claim 13, wherein the heat exchanger comprises a fuel pathway wrapped around an exhaust pathway.

15. The fuel injection system, as claimed in claim 13, having means to measure temperature of the fuel.

16. The fuel injection system, as claimed in claim 15, having means to control the amount of heat produced by the heat exchanger in response to the measured temperature, so that the temperature of the fuel can be kept at a desired value.

17. The fuel injection system, as claimed in claim 13, having means to cool the valve.

18. The fuel injection system, as claimed in claim 13, having a fuel heater.

19. The fuel injection system, as claimed in claim 18, having means to measure a temperature of the fuel.

20. The fuel injection system, as claimed in claim 19, having means to control an amount of heat produced by the heater in response to the measured temperature, so that the temperature of the fuel can be kept at a desired value.
